(19) United States
(12) Patent Application Publication
(10) Pub. No.: US 2022/0245505 A1
(43) Pub. Date: Aug. 4, 2022

(54) METHODS AND APPARATUS FOR MACHINE LEARNING MODEL OPTIMIZATION

(71) Applicant: Walmart Apollo, LLC, Bentonville, AR (US)

(72) Inventors: Chepuri Shiri Krishna, Chennai (IN); Amit Agarwal, Bangalore (IN); Ashish Gupta, Lucknow (IN); Swarnim Narayan, Bangalore (IN); Himanshu Rai, Bangalore (IN); Varun Mishra, Vijay Nagar (IN); Abhinav Rai, Lucknow (IN); Chandrakant Bharti, Ambalipura (IN); Gursirat Singh Sodhi, Chandigarh (IN); Nitin Raj Singh Namdev Balaji, Boduppal (IN)

(21) Appl. No.: 17/162,811

(22) Filed: Jan. 29, 2021

(51) Int. Cl. G06N 20/00

(52) U.S. Cl. CPC G06N 20/00

(57) ABSTRACT

This application relates to apparatus and methods for training machine learning models. In some examples, a pool of worker pods are generated that can execute tasks to train a machine learning model. The pool of work pods are assigned tasks by a master that communicates with the worker pods using a work queue. Each worker pod can provide output using a results queue. The embodiments may operate with less reliable memory, such as object stores, which may be less costly than other types of storage mechanisms. To operate in less reliable environments, each worker pod can include a checkpoint mechanism that can recover from interruptions, such as interruptions due to node failure or preemption. For example, the checkpoint mechanism may allow a worker pod to continue processing a task, when the task is interrupted, from a last checkpoint. Processing results are provided to a results queue when a task completes.

### TECHNICAL FIELD

The disclosure relates generally to machine learning processes and, more specifically, to training machine learning models.

### BACKGROUND

Machine learning models are used for a variety of purposes. For example, machine learning models are used in artificial intelligence (AI) systems, such as in natural language processing (NLP) applications, and in vision-based applications, among other examples. Developing these machine learning models requires various testing efforts before a machine learning model has been selected and ready for application. For example, machine learning models often require training before they are deployed for application. For example machine learning models, such as deep learning models, may be trained in supervised, or unsupervised, modes. The training process may include configuring learning rates and training the machine learning models to fine-tune hyper-parameters (e.g., weights). The machine learning models may also be validated (e.g., tested) to assure they are ready for application.

Many configuration decisions are often needed before a particular machine learning model is selected. For example, a designer may need to decide on a type of pre-processing, algorithm (e.g., support vector machine, logic regression, etc.), choice of kernel (e.g., polynomial, linear), and a choice of regularizer type (e.g., L1, L2). In some examples, various versions of a similar machine learning model are configured and trained to determine a best candidate for a particular application. For example, various versions of a machine learning model, each with a different hyper-parameter configuration, may be trained and tested. In addition, there are various types of machine learning models available. Often times, various types of machine learning models are trained and tested to determine the best model for a particular application.

The selection, configuration, and training of machine learning models consumes processing resources and time, especially when machine learning models are trained over large datasets. Third parties, such as cloud service providers, often provide processing resources that may be used for training machine learning models. Typically, the third parties charge for use of the processing resources based on the type of processing resources requested. These processing resources may include, for example, processor availability and/or speed, and memory requirements, such as memory reliability. As such, there are opportunities to improve the training of machine learning models.

### SUMMARY

The embodiments described herein are directed to methods and apparatus to training machine learning models. The embodiments may generate a pool of worker pods that can execute a job (e.g., a hyper-parameter optimization algorithm) train the machine learning model in parallel. The pool of work pods are assigned jobs by a master that communicates with the worker pods using a work queue. Each worker pod can provide output using a results queue. The embodiments may operate with less reliable memory, such as object stores, which may be less costly than other types of storage mechanisms. To operate in less reliable environments, each worker pod can include a checkpoint mechanism that can recover from interruptions, such as interruptions due to node failure or preemption. The checkpoint mechanism may allow a worker pod to continue processing a task, when the task is interrupted, from a last “checkpoint,” rather than starting the task from the beginning. The master, worker pods, and work and results queues may be deleted upon completion of the job.

As a result the embodiments may provide a more reliable and scalable platform for efficient hyper-parameter optimization that can operate in failure prone environments. Moreover, the embodiments may reduce the amount of time necessary to train machine learning models, such as when testing various versions of the same or different machine learning models. The embodiments may also reduce costs associated with training and validating machine learning models, such as by allowing for more efficient training of the machine learning models in less costly environments. For example, the embodiments may allow machine learning training jobs to execute on less reliable computing devices, such as pre-emptible graphic processing units (GPUs), with marginal, if any, increase in wall-clock processing times. Persons of ordinary skill in the art having the benefit of these disclosures may recognize these and other benefits of the embodiments as well.

In accordance with various embodiments, exemplary systems may be implemented in any suitable hardware or hardware and software, such as in any suitable computing device. For example, in some embodiments, a computing device receives a request identifying a payload for execution. The computing device generates a work queue, a results queue, and a plurality of pods, each pod comprising a checkpoint synchronization container and a checkpoint recovery container. The checkpoint synchronization container is configured to iteratively store a value in an object store when the corresponding pod processes a threshold amount of data. The checkpoint recovery container is configured to read the value in the object store before processing the threshold amount of data, and determine, based on the value, whether the threshold amount of data was previously processed. The computing device also generates tasks based on the payload, and provides the tasks to the work queue to be processed by the plurality of pods. The computing device receives processing results from the plurality of pods from the work queue.

In some embodiments, a computing device is configured to receive a request identifying a payload for execution. The computing device is also configured to generate a plurality of tasks based on the payload, and further to generate a work queue, a results queue, and a plurality of pods, each of the plurality of pods comprising a checkpoint synchronization container and a checkpoint recovery container. The computing device is configured to configure the checkpoint synchronization container for each pod to iteratively store a value in an object store when the corresponding pod processes a threshold amount of data for a task of the plurality of tasks. Further, the computing device is configured to configure the checkpoint recovery container for each pod to read the value in the object store before processing the task, and determine, based on the value, a data location to begin processing the data. The computing device is further configured to provide the plurality of tasks to the work queue to be processed by the plurality of pods. The computing device is also configured to receive processing results of the plurality of pods from the work queue.

In some embodiments, a computing device is configured to receive a task from a work queue, and read a value from an object store based on the task. The computing device is also configured to determine a data location of data to process based on the value. Further, the computing device is configured to process a threshold amount of the data starting from the data location to generate output data. The computing device is also configured to determine if the task is complete. The computing device is configured to update the value in the object store when the task is not complete, and write the output data to a results queue when the task is complete.

In some embodiments, a method is provided that includes receiving a request identifying a payload for execution. The method also includes generating a plurality of tasks based on the payload, and generating a work queue, a results queue, and a plurality of pods, each of the plurality of pods comprising a checkpoint synchronization container and a checkpoint recovery container. The method further includes configuring the checkpoint synchronization container for each pod to iteratively store a value in an object store when the corresponding pod processes a threshold amount of data for a task of the plurality of tasks. Further, the method includes configuring the checkpoint recovery container for each pod to read the value in the object store before processing the task, and determining, based on the value, a data location to begin processing the data. The method also includes providing the plurality of tasks to the work queue to be processed by the plurality of pods. The method further includes receiving processing results of the plurality of pods from the work queue.

In some embodiments, a method is provided that includes receiving a task from a work queue, and reading a value from an object store based on the task. The method also includes determining a data location of data to process based on the value. Further, the method includes processing a threshold amount of the data starting from the data location to generate output data. The method also includes determining if the task is complete. The method further includes updating the value in the object store when the task is not complete, and writing the output data to a results queue when the task is complete.

In yet other embodiments, a non-transitory computer readable medium has instructions stored thereon, where the instructions, when executed by at least one processor, cause a computing device to perform operations that include receiving a request identifying a payload for execution. The operations also include generating a plurality of tasks based on the payload, and generating a work queue, a results queue, and a plurality of pods, each of the plurality of pods comprising a checkpoint synchronization container and a checkpoint recovery container. The operations further include configuring the checkpoint synchronization container for each pod to iteratively store a value in an object store when the corresponding pod processes a threshold amount of data for a task of the plurality of tasks. Further, the operations include configuring the checkpoint recovery container for each pod to read the value in the object store before processing the task, and determining, based on the value, a data location to begin processing the data. The operations also include providing the plurality of tasks to the work queue to be processed by the plurality of pods. The operations further include receiving processing results of the plurality of pods from the work queue.

In yet other embodiments, a non-transitory computer readable medium has instructions stored thereon, where the instructions, when executed by at least one processor, cause a computing device to perform operations that include receiving a task from a work queue, and reading a value from an object store based on the task. The operations also include determining a data location of data to process based on the value. Further, the operations include processing a threshold amount of the data starting from the data location to generate output data. The operations also include determining if the task is complete. The operations further include updating the value in the object store when the task is not complete, and writing the output data to a results queue when the task is complete.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an e-commerce system that includes machine learning model optimization, in accordance with some embodiments;

FIG. 2 is a block diagram of the machine learning model optimization (MLMO) computing device of the e-commerce system of FIG. 1, in accordance with some embodiments;

FIG. 3 is a block diagram illustrating examples of various portions of the MLMO computing device of FIG. 2, in accordance with some embodiments;

FIG. 4A is a block diagram of worker pods of a worker pool in communication with a master node, in accordance with some embodiments;

FIG. 4B is a block diagram of a data manager pod in communication with a training container of a work pod, in accordance with some embodiments;

FIG. 5A is a diagram illustrating exemplary runtimes and costs in pre-emptible and non-pre-emptible environments, in accordance with some embodiments;

FIG. 5B is a diagram illustrating exemplary wall times with respect to the use of parallelism, in accordance with some embodiments

FIG. 6 is a flowchart of example method that can be carried out by the MLMO computing device of FIG. 2, in accordance with some embodiments; and

FIG. 7 is a flowchart of another example method that can be carried out by the MLMO computing device of FIG. 2, in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

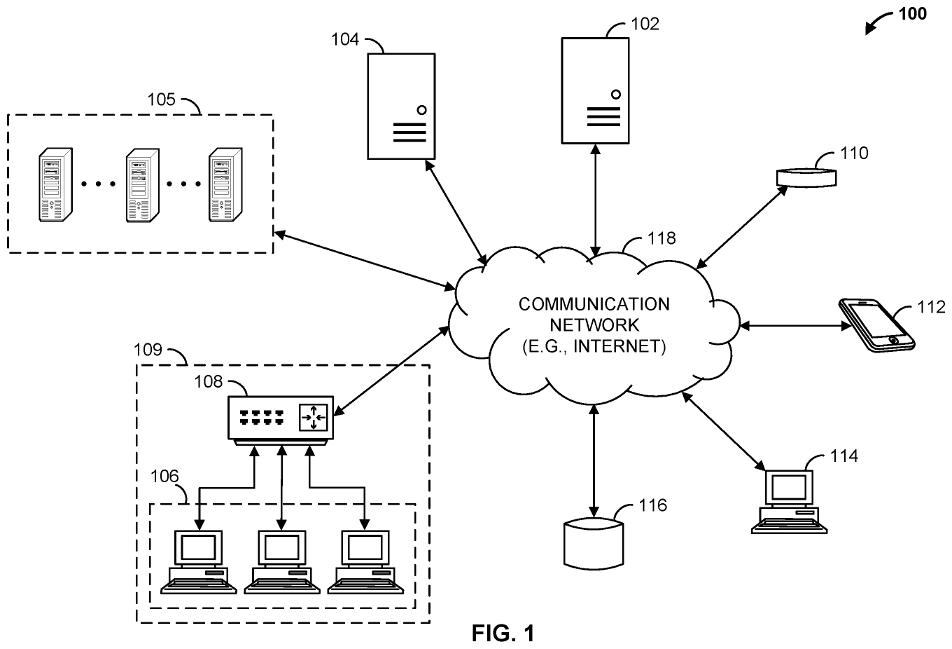

Turning to the drawings, FIG. 1 illustrates a block diagram of an e-commerce system 100 that includes a machine learning model optimization (MLMO) computing device 102 (e.g., a server, such as an application server), a web server 104, workstation(s) 106, a database 116, cloud computing servers 105, and multiple customer computing devices 110, 112, 114, each operatively coupled over network 118.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

MLMO computing device 102, workstation(s) 106, web server 104, cloud computing servers 105, and multiple customer computing devices 110, 112, 114 can each be any suitable computing device that includes any hardware or hardware and software combination for processing data. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 118.

In some examples, MLMO computing device 102 can be a computer, a workstation, a laptop, a server such as a cloud-based server, or any other suitable device. In some examples, each of multiple customer computing devices 110, 112, 114 can be a cellular phone, a smart phone, a tablet, a personal assistant device, a voice assistant device, a digital assistant, a laptop, a computer, or any other suitable device. In some examples, MLMO computing device 102, item recommendation system 105, and web server 104 are operated by a retailer, and multiple customer computing devices 112, 114 are operated by customers of the retailer. Cloud computing servers 105 may be operated by a cloud computing services operator or, in some examples, the retailer.

Although FIG. 1 illustrates three customer computing devices 110, 112, 114, e-commerce system 100 can include any number of customer computing devices 110, 112, 114. Similarly, e-commerce system 100 can include any number of workstation(s) 106, MLMO computing devices 102, web servers 104, cloud computing servers 105, and databases 116.

Database 116 can be a remote storage device, such as a cloud-based server, a disk (e.g., a hard disk), a memory device on another application server, a networked computer, or any other suitable remote storage. Although shown remote to MLMO computing device 102, in some examples, database 116 can be a local storage device, such as a hard drive, a non-volatile memory, or a USB stick. Database 116 may store, for example, customer purchase data and/or customer session data. Database 116 may also store catalog data, which may identify one or more attributes of each of a plurality of items, such as attributes of items sold at store 109 items sold on a website hosted by web server 104. Attributes may include, for example, an item brand, an item price, an item quantity, item options, and an item title and/or item description.

Workstation(s) 106 is operably coupled to communication network 118 via router (or switch) 108. Workstation(s) 106 and/or router 108 may be located at a store 109, for example. Workstation(s) 106 can communicate with database 116 over communication network 118. The workstation(s) 106 may send data to, and receive data from, database 116. For example, the workstation(s) 106 may store purchase data related to orders purchased by customers at store 109 within database 116. The purchase data may include, for example, one or more of a price, identification number (e.g., Universal Product Number), quantity, brand, size, and option of each item purchased. Similarly, web server 104 and MLMO computing device 102 may store data to, or read data from, database 116.

In some examples, web server 104 hosts one or more websites, such as a retailer's website. Customers, via one or more customer computing devices 110, 112, 114, may access the website, which may allow customers to purchase items. For example, the website may advertise items for sale. The website may allow customers to add items to an online shopping cart, and purchase the items within the online shopping cart. In some examples, web server 104 captures customer session data and/or customer purchase data, and stores the customer session data and customer purchase data within database 116. Customer session data may include, for example, item engagements (e.g., item and advertisement clicks, item and advertisement impressions, add-to-cart (ATC) events, etc.), and search queries, for a customer. Customer purchase data may identify, for example, items purchased on the website, and information about each item purchased (e.g., price, quantity, brand, size, options, description, etc.).

In some examples, web server 104 determines items to advertise to a customer based on the application of one or more trained machine learning models to customer session data and/or customer purchase data. For example, web server 104 may apply a deep learning model, a neural network, a decision tree model, a gradient descent model, or any other suitable machine learning model to customer session data and/or customer purchase data to determine items to advertise to a customer. In some examples, web server 104 may determine one or more search results for the customer in response to receiving a search query. For example, the customer may provide one or more search terms within a search bar of the website. Web server 104 may apply a machine learning model to the search terms to determine one or more items to advertise to the customer (e.g., search results). Web server 104 may display the item advertisements within a search results page of the website.

In some examples, MLMO computing device 102 trains the machine learning models, and stores the trained machine learning models within database 116. Web server 104 may obtain the trained machine learning models from database 116, and apply the trained machine learning models to determine item advertisements to provide to the customer.

MLMO computing device 102 may provide a reliable and scalable platform for efficient hyper-parameter optimization. For example, MLMO computing device 102 may operate the platform to execute processing tasks to optimize hypo-parameters of a machine learning model. The platform may be integrated within a system for automating deployment, scaling, and management of containerized applications, such as Kubernetes®. The platform can operate in various failure scenarios and can be resilient to high load factors. The platform can leverage parallelism (e.g., a plurality of processing units simultaneously executing processing tasks) to reduce processing times and compute costs. The platform may provide high availability of various components, may durably maintain job state to ensure recoverability from failures, and can be configured to trade off wall clock times against compute costs. The platform may also scale based on job loads.

Cloud computing servers 105 may provide compute resources, such as graphical processing units (GPUs) and memory (e.g., object stores). For example, a cloud computing service provider may operate cloud computing servers 105, and charge an amount of money (e.g., compute costs) based on the type of resource allocated. As an example, the provider may charge a first amount (e.g., $2 an hour) for non-pre-emptible processing units, such as GPUs, and a second amount (e.g., $0.30 an hour) for pre-emptible processing units. The pre-emptible processing units may be unreliable, as they may be interrupted to perform other processing tasks. MLMO computing device 102 may provide processing tasks to cloud computing servers 105, such as hyper-parameter optimization tasks, when training machine learning models.

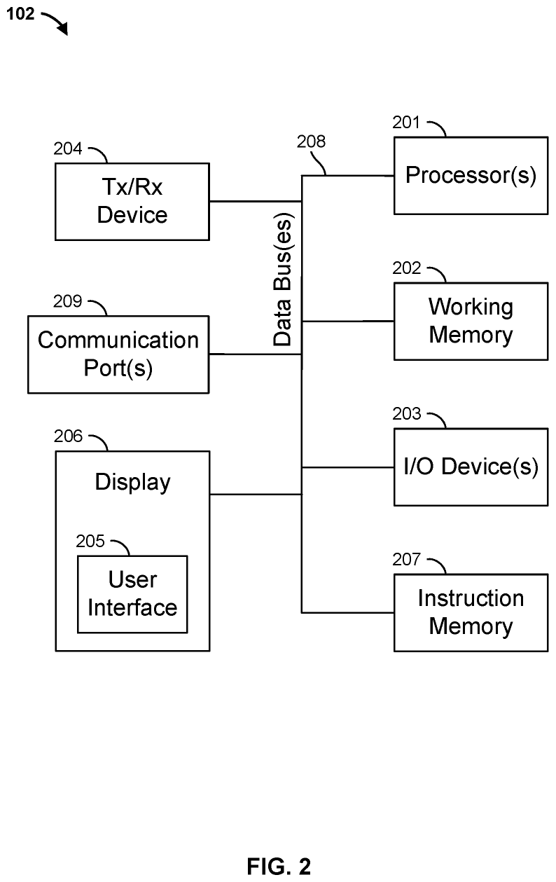

FIG. 2 illustrates the MLMO computing device 102 of FIG. 1. MLMO computing device 102 can include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more processing cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of MLMO computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allows for the transfer (e.g., uploading or downloading) of data, such as the uploading of executable instructions to be executed by processor 201 and stored in instruction memory 207.

Display 206 can display user interface 205. User interfaces 205 can enable user interaction with MLMO computing device 102. For example, user interface 205 can be a user interface for an application that allows for the selection of machine learning models to be trained, and for trained machine learning models to be provided to web server 104 to generate item advertisements. In some examples, a user can interact with user interface 205 by engaging input-output devices 203. In some examples, display 206 can be a touchscreen, where user interface 205 is displayed by the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 MLMO computing device 102 will be operating in. Processor(s) 201 is operable to receive data from, or send data to, a network, such as communication network 118 of FIG. 1, via transceiver 204.

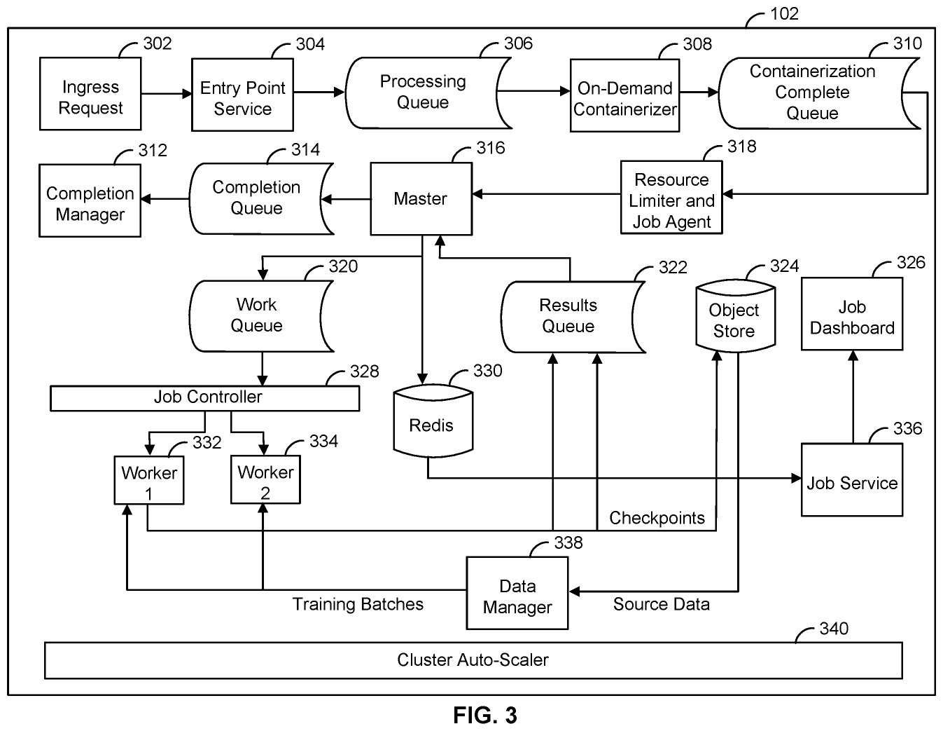

FIG. 3 illustrates exemplary portions of the MLMO computing device 102 of FIG. 1. Each of the illustrated functions may be implemented, for example, by one or more processors 201 executing instructions stored within instruction memory 207. In this example, MLMO computing device 102 receives an ingress request 302, which identifies a job payload (e.g., a hyper-parameter optimization processing task). The ingress request 302 may be, for example, an HTTP POST request that includes the job payload. The HTTP POST request may be received via communication network 118 from another computing device, such as a workstation, for example. In some examples, the ingress request 302 is generated in response to input received from a user via user interface 205, such as an executed application that allows the user to select a machine learning model for training. Entry point service 304 receives ingress request 302, and validates ingress request 302, such as by verifying a checksum. For example, entry point service 304 may calculate a checksum based on the received job payload, and may compare the computed checksum to a received checksum. Entry point service 304 may determine the job payload is validated when the checksums match. Entry point service 304 places the job payload in processing queue 306.

On-demand containerizer 308 obtains the job payload from processing queue 306, and generates master and worker images. For example, on-demand containerizer 308 parses the job payload, and generates the master image and the worker image based on the parsed job payload in accordance with a framework (e.g., containers, such as Kubernetes® containers). On-demand containerizer 308 stores the master and worker images within containerization complete queue 310.

Resource limiter and job agent 318 acquires resources, such as memory resources, obtains the master and worker images from the containerization complete queue 310, and executes the master image to establish master 316. Resource limiter and job agent 318 further establishes work queue 320, and results queue 322. Each of work queue 320 and results queue 322 may be located within the obtained memory resources, such as within (e.g., reliable, non-pre-emptible) non-volatile memory, or, in some examples, cache memory. In some examples, each of work queue 320 and results queue 322 are mirrored (e.g., duplicated) to increase reliability.

Once established, master 316 generates a pool of worker pods, such as first worker pod 332 and second worker pod 334. The pool of worker pods are generated based on the work image. For example, the worker image may define the functions of a worker pod. Further, master 316 is configured to provide processing tasks (e.g., hyper-parameter optimization tasks) to work queue 320. Job controller 328 is configured to obtain the processing tasks from the work queue 320, and provide them to a worker pod 332, 334.

Worker pods 332, 334 are configured to operate on training batches provided by data manager 338. For example, data manager 338 may obtain source data (e.g., customer session data, customer purchase data) from object store 324. Data manager 338 may generate, based on the source data, training data that includes one or more epochs of data to train machine learning model processing tasks executed by the worker pods 332, 334. Data manager 338 provides the training batches to the worker pods 332, 334, and the worker pods 332, 334 apply their respective processing tasks to the corresponding training batches.

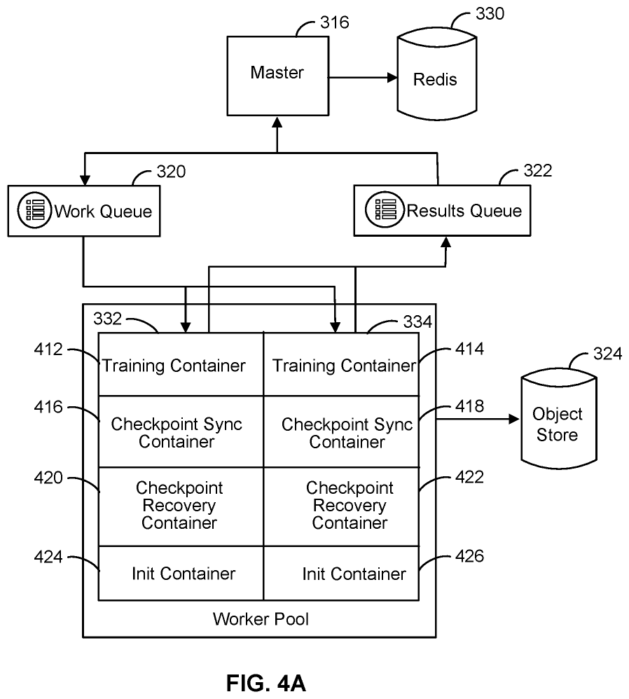

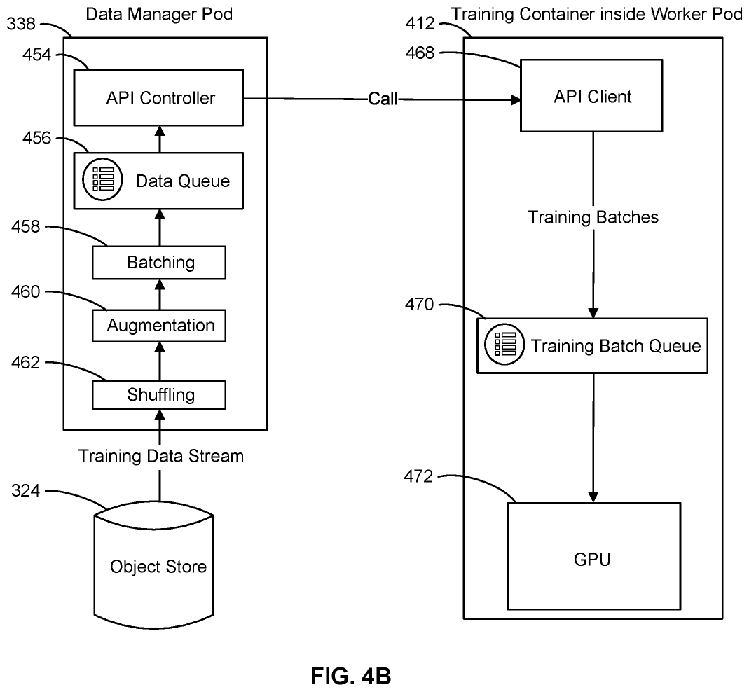

Further, worker pods 332, 334 occasionally stores checkpoint data within object store 324. In some examples, the checkpoint data may include a checksum (e.g., an ID), a timestamp, and an epoch number. Each worker pod 332, 334 may use the checkpoint data to determine where to begin processing a processing task. As described in further detail with respect to FIG. 4A, each worker pod 332, 334 may occasionally store the checkpoint data in object store 324 for a given processing task. For example, each worker pod 332, 334 may store a checksum for a given processing task after every epoch of training batches is processed. In some examples, each worker pod 332, 334 stores the checkpoint data after a preconfigured period of time, or after processing a fraction of an epoch of data, for example.

Assuming the processing task is interrupted (e.g., fails), a worker pod 332, 334 that is reassigned the same processing task may obtain the checkpoint data from the object store 324, and determine where in a given training batch to begin applying the processing task. For example, the worker pod 332, 334 may determine, based on the epoch number, that last epoch of training batches to have been processed. The worker pod 332, 334 may begin executing the assigned processing task with the next epoch of data.

In some examples, the worker pod 332, 334 may further verify that the processing task was recently executed based on the timestamp. For example, the worker pod 332, 334 may determine an amount of time that has elapsed since the timestamp. If the amount of time is greater than a threshold amount of time, the worker pod 332, 334 may execute the processing task as if no processing of the processing task has previously taken place. In some examples, the worker pod 332, 334 computes a checksum, and compares the computed checksum to the checksum of the checkpoint data. If the checksums match, the worker pod 332, 334 executes the processing task beginning with the next epoch as determined by the corresponding epoch number. Otherwise, if the checksums do not match, the worker pod 332, 334 executes the processing task as if no processing of the processing task has previously taken place.

Once a processing task is complete, the worker pods 332, 334 store processing results (e.g., all or portions of a trained machine learning model) in results queue 322. In some examples, each worker pod 332, 334 also deletes the checkpoint data from the object store 324. In some examples, the checkpoint data is updated with a “complete” value, such as 0xFFFF. Master 316 is configured to obtain the processing results from the results queue 322, and provide the processing results of multiple worker pods 332, 334 to a completion queue 314. Completion manager 312 obtains the processing results from the completion queue 314, and provides the processing results in response to the ingress request. In some examples, at the completion of a job (e.g., payload has been completely processed), completion manager 312 deletes master 316 and the associated worker pods 332, 334, as well as the work queue 320 and the results queue 322.

In some examples, master 316 provides status information to redistribute store 330. Job service 336 is able to obtain the status information from redistribute store 330, and provide the status information to job dashboard 326. A user may view the job status via the job dashboard 326, which may be displayed via a user interface 205.

Cluster auto-scaler 340 may perform additional operations. For example, cluster auto-scaler 340 may reduce node underutilization and compute costs through dynamic node provisioning. In addition, cluster auto-scaler 340 may shift in-progress jobs (e.g., as executed by worker pods 332, 334) out of unavailable nodes (e.g., GPUs) to available nodes. As such, less costly compute nodes may be employed for processing the jobs. Further, cluster auto-scaler 340 may employ a heartbeat mechanism to detect unresponsive nodes and/or worker pods 332, 334. If a node and/or worker pod 332, 334 fails to respond to a heartbeat request (e.g., with a heartbeat response) within a predetermined amount of time (e.g., 200 msecs, 1 sec, 1 minute, etc.), cluster auto-scaler 340 can re-queue messages that were supposed to be processed by those nodes and/or worker pods 332, 334.

In some examples, all or portions of the above identified functions are performed by cloud servers 105. For example, MLMO computing device 102 may transmit an ingress request 302 to a cloud computing server 105 hosted by a cloud service provider. The cloud computing server 105 may execute one or more of the worker pods 332, 334 with pre-emptible processing units, such as pre-emptible GPUs. Once the job payload has been processed, the cloud computing sever 105 may transmit the processing results to MLMO computing device 102. For example, a completion manager 312 of the cloud computing server 105 may transmit the results stored within the completion queue 314 to MLMO computing device 102 in response to the ingress request 302.

FIG. 4A illustrates further details of the worker pods 332, 334. Each worker pod 332, 334 includes a corresponding training container, checkpoint synchronization container, checkpoint recovery container, and an initialization container. For example, worker pod 332 includes training container 412, checkpoint synchronization container 416, checkpoint recovery container 420, and initialization container 424. Worker pod 334 includes training container 414, checkpoint synchronization container 418, checkpoint recovery container 422, and initialization container 426.

Upon receiving a new processing task from work queue 406, the initialization container 424, 426 obtains checkpoint data (e.g., the most recent checkpoint data based on the timestamp) from object store 324. Checkpoint recovery container 420, 422 determines whether the processing task was previously started based on the checkpoint data. For example, the checkpoint data may include an epoch number. Checkpoint recovery container 420, 422 may determine that the processing task is complete at least through the epoch of training data indicated by the epoch number. Checkpoint recovery container 420, 422 may, in some examples, determine the processing task was never completed when, for example, there is no checkpoint data within the object store 324, or when the checkpoint data indicates the current processing task never started (e.g., that the previous processing task was complete, via a checksum of 0xFFFF).

Further, checkpoint recovery container 420, 422 may generate recovery data (e.g., a memory location, a pointer value, a memory offset value, etc.) indicating a location from where to begin processing training batches from data manager 338. The corresponding training container 412, 414 may then begin to execute the processing task (e.g., training hyper-parameters of a machine learning model) based on the recovery data. For example, the training container 412, 414 may begin processing a current training batch from the location indicated by the recovery data.

As an example, assuming checkpoint data indicates an epoch number of 5, checkpoint recovery container 420, 422 may generate recover data indicating a location from where to begin processing epoch number 6 of training data. The corresponding training container 412, 414 may then begin to execute the processing task using training data corresponding to epoch 6.

Checkpoint synchronization container 416, 418 may, during execution of the processing task, update checkpoint data within object store 324. For example, the checkpoint synchronization container may update the checkpoint data with an epoch number after processing an epoch of training batches received by data manager 338. In some examples, the checkpoint synchronization container increases the epoch number (e.g., by 1) after each epoch of training batches is processed. In some examples, the checkpoint synchronization container updates a timestamp (e.g., based on a current date and time), such as when an epoch of training batches has been processed. In some examples, the checkpoint synchronization container computes a checksum (e.g., based on the most recent epoch data processed). Checkpoint synchronization container may store the timestamp and checksum as part of the checkpoint data in object store 324.

As an example, upon initialization, a worker pod 332, 334, via its corresponding checkpoint recovery container 420, 422, may determine that no checkpoint data has been written to object store 324. As such, each worker pod 332, 334, via its training container 412, 414, may begin training a portion of a machine learning model with training data from an initial location of a first epoch of training data received as training batches from data manager 338 (e.g., location 0 of epoch 0). Assume the worker pod 332, 334 processes for epochs (e.g., epochs 0-3) of training data and, after completion of each epoch, updates checkpoint data with the epoch number. As such, after the fourth epoch, the checkpoint synchronization container 416, 418 writes a “3” to the object store 324. Further assume that, during the fifth epoch (e.g., epoch 4), the worker pod 332, 334 encounters a failure (e.g., is pre-empted).

Cluster auto-scaler 340 may periodically send a heartbeat request to the worker pod 332, 334. Because the worker pod 332, 334 has failed, the worker pod 332, 334 fails to respond to any heartbeat requests after the failure. Cluster auto-scaler 340 may determine that the worker pod 332, 334 fails to respond with a heartbeat response to a heartbeat request within a threshold amount of time. As such, cluster auto-scaler 340 may reschedule the processing task (e.g., via master 316). For example, cluster auto-scaler 340 may cause (e.g., send a message to) the master 316 to re-queue the processing task within the work queue 320.

Job controller 328 may assign the processing task to another worker pod 332, 334. The worker pod 332, 334, via its initialization container 424, 426, may obtain the checkpoint data from the object store 324. The worker pod 332, 334, in this example, may, via its checkpoint recovery container 420, 422, determine that, based on the epoch number obtained from the checkpoint data, the last epoch of training data to be processed was epoch 3. As such, the worker pod 332, 334 generates recovery data indicating a location from where to begin processing epoch 4, and the corresponding training container continues to train the portion of the machine learning model with epoch 4 training data.

In some examples, worker pods 332, 334 are assigned to various processing units (e.g., GPUs) to be executed in parallel. For example, job controller 328 may assign a first plurality of worker pods 332, 334 to execute on a first GPU, and a second plurality of worker pods 332, 334 to execute on a second GPU.

FIG. 4B illustrates an exemplary data manager 338 in communication with a training container of a worker pod, such as training containers 412, 414. Data manager 338 may include a shuffling module 462, an augmentation module 460, a batching module 458, a data queue module 456, and an application programming interface (API) controller 454. Shuffling module 462 receives the training data stream from object store 324, shuffles the training data, and provides the shuffled training data to augmentation 460. Augmentation 460 augments the shuffled training data, and provides the shuffled training data to batching model 458

Batching module 458 batches the training data into batch sizes, and stores the batched training data (i.e., batches) within data queue 456. API controller 454 obtains the batches from the data queue 456, and provides the batches to an API client 468 of a training container 412. The API client 468 stores the batches within training batch queue 470. A processing unit, such as GPU 472, obtains the batches from the training batch queue, and trains a machine learning model with the batches. Although only one GPU 472 is illustrated, a worker pod 332, 334 may execute on multiple GPUs.

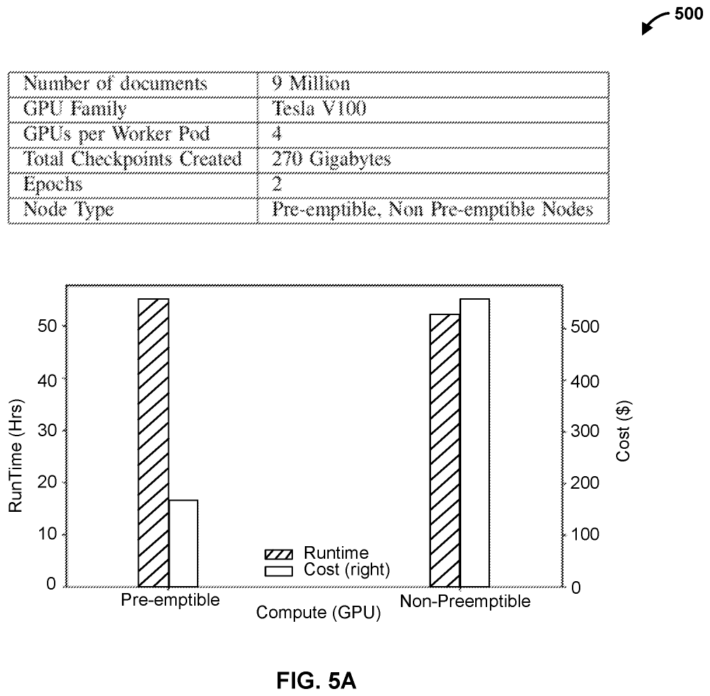

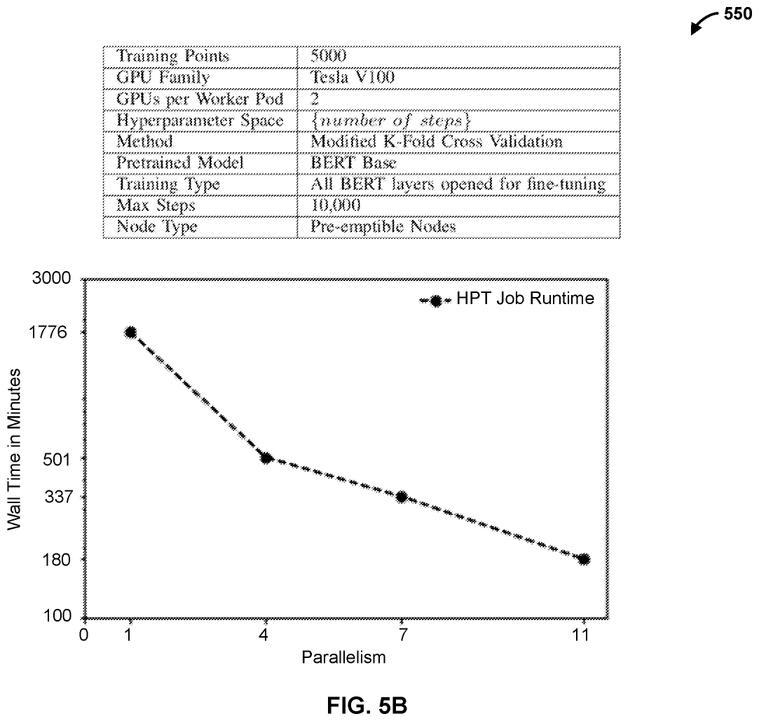

FIG. 5A illustrates a diagram 500 identifying exemplary runtimes and costs in a pre-emptible environment using the MLMO computing device 102 platform described herein, versus a non-pre-emptible environment. A pre-emptible environment (e.g., as provided by cloud servers 105) may cost significantly less (e.g., $0.30 per hour vs. $2.00 per hour) than a non-pre-emptible environment. As indicated in the chart, although the runtime on the pre-emptible environment is slightly higher than in the non-pre-emptible environment (e.g., 55 hours versus 50 hours), the costs are significantly lower ($175 versus $550).

FIG. 5B illustrates a diagram 550 identifying wall clock times versus the use of parallelism when using the MLMO computing device 102 platform described herein. In this example, a BERT model is trained. The numbers along the horizontal axis identify a number of parallel trainer pods created, where each trainer pod may have one or more GPUs. As indicated, wall clock times decreases as parallelism increases.

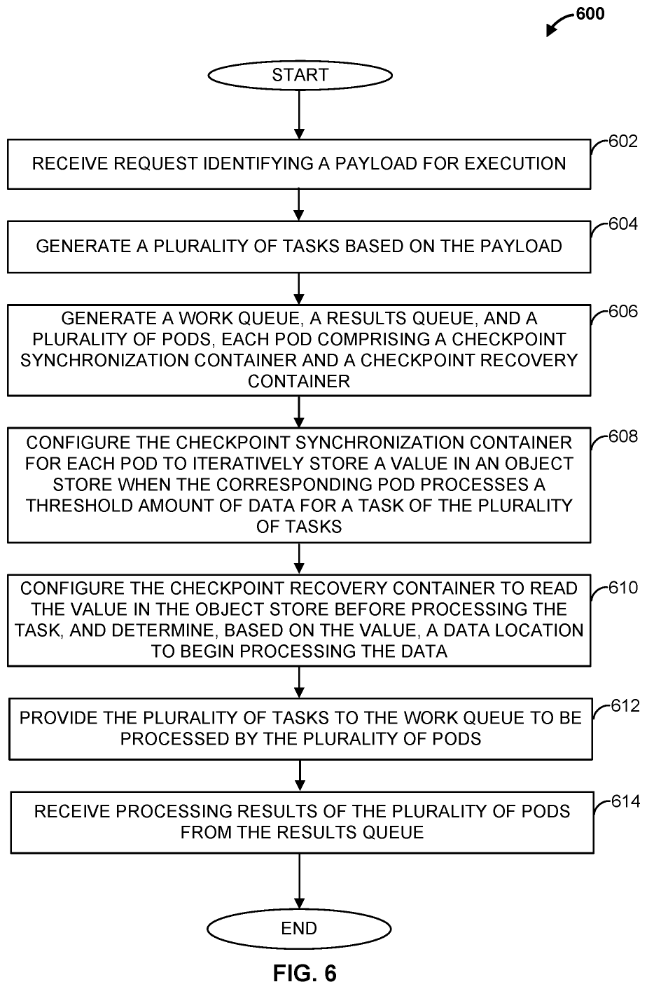

FIG. 6 is a flowchart of an example method 600 for processing tasks, such as training hyper-parameters of a machine learning model, and can be carried out by the MLMO computing device 102 of FIG. 2. Beginning at step 602, a request is received that identifies a payload for execution. For example, MLMO computing device 102 may receive an ingress request 302 that includes a payload. The request may be, for example, an HTTP POST. At step 604, a plurality of tasks are generated based on the payload. Further, at step 606, a work queue, a results queue, and a plurality of pods are generated. Each pod comprises a checkpoint synchronization container and a checkpoint recovery container. For example, MLMO computing device 102 may generate work queue 320, results queue 322, and worker pods 332, 334, where each worker pod 332, 334 includes a respective checkpoint synchronization container 416, 418, and a respective checkpoint recovery container 420, 422.

Proceeding to step 608, each checkpoint synchronization container is configured to iteratively store a value in an object store when a threshold amount of data is processed for a task. For example, MLMO computing device 102 may configure each checkpoint synchronization container 416, 418 to write checkpoint data (e.g., an epoch number, timestamp, checksum) into object store 324 after processing an epoch of training data.

At step 610, the checkpoint recovery container is configured to read the value in the object store before processing the task, and to determine, based on the value, a data location to begin processing the data. For example, MLMO computing device 102 may configure each checkpoint recovery container 420, 422 to read checkpoint data from the object store 324, and determine whether the task has previously processed batches of training data. For example, checkpoint recovery container 420, 422 may determine a last epoch of training data to be processed based on an epoch number stored with the checkpoint data. As another example, checkpoint recovery container 420, 422 may determine that the task has not previously processed training data, based on there being no checkpoint data within the object store 324, or based on the checkpoint data indicating that the previous processing task was complete, such as a checksum of 0xFFFF.

At step 612, the plurality of tasks are provided to the work queue to be processed by the plurality of pods. For example, master 316 may write the plurality of tasks to work queue 320 to be processed by a pool of worker pods. The plurality of pods may obtain the plurality of tasks from the queue (e.g., in first in first out (FIFO) order), and process the tasks. Each checkpoint container of each pod may, before processing a task, read the value in the object store before processing the task, and to determine, based on the value, a data location to begin processing the data (e.g., as configured in step 610). Further, as each pod processes a task, each checkpoint synchronization container may store the value in the object store when the threshold amount of data is processed (e.g., as configured in step 608).

At step 614, processing results from the pods are retrieved from the results queue. For example, master 316 may retrieve processing results from the pool of worker pods from results queue 322. The method then ends.

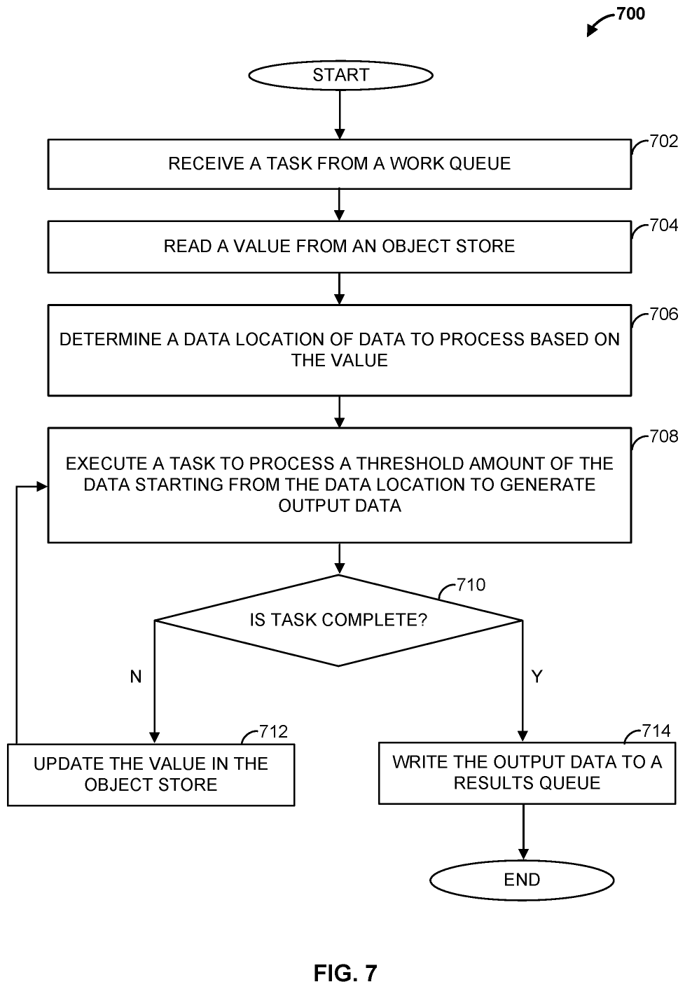

FIG. 7 is a flowchart of an example method 700 for processing tasks, such as training hyper-parameters of a machine learning model, and can be carried out by the MLMO computing device 102 of FIG. 2. Beginning at step 702, a task is received from a work queue (e.g., work queue 320). At step 704, a value is read from an object store (e.g., epoch number stored in object store 324). At step 706, a data location of data to process is determined based on the value. For example, MLMO computing device 102 may determine a location of where to begin processing a batch of training data based on a read epoch number. The location may be the starting location of the next epoch of training data.

Proceeding to step 708, a task is executed to process threshold amount of data, starting from the data location determined in step 706, to generate output data. The output data may identify predictions of a machine learning model, for example. At step 710, a determination is made as to whether the task is complete. If the task is not complete, the method proceeds to step 712, where the value is updated in the object store. For example, an epoch number may be increased (e.g., by one). The method then proceeds back to step 708 to continue executing the task. If, at step 710, the task is complete, the method proceeds to step 714, where the output data is written to a results queue (e.g., results queue 322). The method then ends.

In some examples, a system comprises a computing device that is configured to receive a request identifying a payload for execution. The computing device is also configured to generate a plurality of tasks based on the payload. Further, the computing device is configured to generate a work queue and a results queue. The computing device is also configured to generate a plurality of pods, each of the plurality of pods comprising a checkpoint synchronization container and a checkpoint recovery container. The checkpoint synchronization container for each pod is configured to iteratively store a value in an object store when the corresponding pod processes a threshold amount of data for a task of the plurality of tasks. Additionally, the checkpoint recovery container for each pod is configured to read the value in the object store before processing the task, and determine, based on the value, a data location to begin processing the data. The computing device is also configured to provide the plurality of tasks to the work queue to be processed by the plurality of pods. Further, the computing device is configured to receive processing results of the plurality of pods from the results queue.

In some examples, the computing device is configured to generate a master node, wherein the master node is configured to write the plurality of tasks to the work queue, and retrieve the processing results from the results queue.

In some examples, each of the plurality of pods comprise a training container, wherein the training container is configured to execute the task based on the data location.

In some examples, the payload for execution comprises instructions for training hyper-parameters of a machine learning model.

In some examples, the value comprises an epoch number.

In some examples, the computing device is configured to assign the plurality of pods to a plurality of processing units, wherein the plurality of processing units execute at least two of the plurality of tasks in parallel.

In some examples, the computing device is configured to generate a data manager, wherein the data manager is configured to provide batches of the data to the plurality of worker pods. In some examples, the data manager is configured to transmit a heartbeat request to each of the plurality of worker pods, and wherein each of the worker pods are configured to respond to each heartbeat request with a heartbeat response. In some examples, the data manager is configured to determine that a heartbeat response has not been received in a threshold amount of time since a heartbeat request was transmitted to a first worker pod of the plurality of worker pods, and to provide to the work queue a first task of the plurality of tasks that was being processed by the first worker pod.

In some examples, the checkpoint recovery container for each of the plurality of pods is configured to read the value in the object store before processing the task, and determine, based on the value, that the data has not been processed.

In some examples a method includes receiving a request identifying a payload for execution, and generating a plurality of tasks based on the payload. The method also includes generating a work queue and a results queue. Further, the method includes generating a plurality of pods, each of the plurality of pods comprising a checkpoint synchronization container and a checkpoint recovery container. The checkpoint synchronization container for each pod iteratively stores a value in an object store when the corresponding pod processes a threshold amount of data for a task of the plurality of tasks. Additionally, the checkpoint recovery container for each pod reads the value in the object store before processing the task, and determine, based on the value, a data location to begin processing the data. The method also includes providing the plurality of tasks to the work queue to be processed by the plurality of pods. Further, the method includes receiving processing results of the plurality of pods from the work queue.

In some examples, the method includes generating a master node, wherein the master node is configured to write the plurality of tasks to the work queue, and retrieve the processing results from the results queue.

In some examples, the method includes generating a training container for each of the plurality of pods, wherein each training container executes the task based on the data location.

In some examples, the method includes assigning the plurality of pods to a plurality of processing units, wherein the plurality of processing units execute at least two of the plurality of tasks in parallel.

In some examples, the method includes generating a data manager, wherein the data manager is configured to provide batches of the data to the plurality of worker pods.

In some examples, a non-transitory computer readable medium has instructions stored thereon where the instructions, when executed by at least one processor, cause a device to perform operations that include receiving a request identifying a payload for execution, and generating a plurality of tasks based on the payload. The operations also include generating a work queue and a results queue. Further, the operations include generating a plurality of pods, each of the plurality of pods comprising a checkpoint synchronization container and a checkpoint recovery container. The checkpoint synchronization container for each pod iteratively stores a value in an object store when the corresponding pod processes a threshold amount of data for a task of the plurality of tasks. Additionally, the checkpoint recovery container for each pod reads the value in the object store before processing the task, and determine, based on the value, a data location to begin processing the data. The operations also include providing the plurality of tasks to the work queue to be processed by the plurality of pods. Further, the operations include receiving processing results of the plurality of pods from the work queue.

In some examples, the non-transitory computer readable medium further includes instructions stored thereon that, when executed by the at least one processor, further cause the device to perform operations that include generating a master node, wherein the master node is configured to write the plurality of tasks to the work queue, and retrieve the processing results from the results queue.

In some examples, the non-transitory computer readable medium further includes instructions stored thereon that, when executed by the at least one processor, further cause the device to perform operations that include generating a training container for each of the plurality of pods, wherein each training container executes the task based on the data location.

In some examples, the non-transitory computer readable medium further includes instructions stored thereon that, when executed by the at least one processor, further cause the device to perform operations that include assigning the plurality of pods to a plurality of processing units, wherein the plurality of processing units execute at least two of the plurality of tasks in parallel.

In some examples, the non-transitory computer readable medium further includes instructions stored thereon that, when executed by the at least one processor, further cause the device to perform operations that include generating a data manager, wherein the data manager is configured to provide batches of the data to the plurality of worker pods.

In some examples, a system comprises a computing device that is configured to receive a request identifying a payload for execution. The computing device is also configured to generate a plurality of tasks based on the payload. Further, the computing device is configured to read a value from an object store before processing a task of the plurality of tasks, and determine, based on the value, a location of a batch of data. The computing device is also configured to apply the task to the batch of data beginning at the determined location to generate output data. The computing device is further configured to update the value in the object store when the task has been applied to a threshold amount of the data. The computing device is also configured to provide the output data when application of the task to the data is complete.

In some examples, a method comprises receiving a request identifying a payload for execution. The method also comprises generating a plurality of tasks based on the payload. Further, the method comprises reading a value from an object store before processing a task of the plurality of tasks, and determining, based on the value, a location of a batch of data. The method also comprises applying the task to the batch of data beginning at the determined location to generate output data. The method further comprises updating the value in the object store when the task has been applied to a threshold amount of the data. The method also comprises providing the output data when application of the task to the data is complete.

In some examples, a non-transitory computer readable medium having instructions stored thereon, wherein the instructions, when executed by at least one processor, cause a device to perform operations comprising receiving a request identifying a payload for execution. The operations also comprise generating a plurality of tasks based on the payload. Further, the operations comprise reading a value from an object store before processing a task of the plurality of tasks, and determining, based on the value, a location of a batch of data. The operations also comprise applying the task to the batch of data beginning at the determined location to generate output data. The operations further comprise updating the value in the object store when the task has been applied to a threshold amount of the data. The operations also comprise providing the output data when application of the task to the data is complete.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
receive a request identifying a payload for execution;
generate a plurality of tasks based on the payload;
generate a work queue and a results queue;
generate a plurality of pods, each of the plurality of pods comprising a checkpoint synchronization container and a checkpoint recovery container, wherein:
the checkpoint synchronization container for each pod is configured to iteratively store a value in an object store when the corresponding pod processes a threshold amount of data for a task of the plurality of tasks; and
the checkpoint recovery container for each pod is configured to read the value in the object store before processing the task, and determine, based on the value, a data location to begin processing the data;
provide the plurality of tasks to the work queue to be processed by the plurality of pods; and
receive processing results of the plurality of pods from the results queue.

2. The system of claim 1, wherein the computing device is configured to generate a master node, wherein the master node is configured to write the plurality of tasks to the work queue, and retrieve the processing results from the results queue.

3. The system of claim 1, wherein each of the plurality of pods comprise a training container, wherein the training container is configured to execute the task based on the data location.

4. The system of claim 1, wherein the payload for execution comprises instructions for training hyper-parameters of a machine learning model.

5. The system of claim 1, wherein the value comprises an epoch number.

6. The system of claim 1, wherein the computing device is configured to assign the plurality of pods to a plurality of processing units, wherein the plurality of processing units execute at least two of the plurality of tasks in parallel.

7. The system of claim 1, wherein the computing device is configured to generate a data manager, wherein the data manager is configured to provide batches of the data to the plurality of worker pods.

8. The system of claim 7, wherein the data manager is configured to transmit a heartbeat request to each of the plurality of worker pods, and wherein each of the worker pods are configured to respond to each heartbeat request with a heartbeat response.

9. The system of claim 8, wherein the data manager is configured to:
determine that a heartbeat response has not been received in a threshold amount of time since a heartbeat request was transmitted to a first worker pod of the plurality of worker pods; and
provide to the work queue a first task of the plurality of tasks that was being processed by the first worker pod.

10. The system of claim 1, wherein the checkpoint recovery container for each of the plurality of pods is configured to read the value in the object store before processing the task, and determine, based on the value, that the data has not been processed.

11. A method comprising:
receiving a request identifying a payload for execution;
generating a plurality of tasks based on the payload;
generating a work queue and a results queue;
generating a plurality of pods, each of the plurality of pods comprising a checkpoint synchronization container and a checkpoint recovery container, wherein:
the checkpoint synchronization container for each pod iteratively stores a value in an object store when the corresponding pod processes a threshold amount of data for a task of the plurality of tasks; and
the checkpoint recovery container for each pod reads the value in the object store before processing the task, and determine, based on the value, a data location to begin processing the data;
providing the plurality of tasks to the work queue to be processed by the plurality of pods; and
receiving processing results of the plurality of pods from the work queue.

12. The method of claim 11, comprising generating a master node, wherein the master node is configured to write the plurality of tasks to the work queue, and retrieve the processing results from the results queue.

13. The method of claim 11, comprising generating a training container for each of the plurality of pods, wherein each training container executes the task based on the data location.

14. The method of claim 11, comprising assigning the plurality of pods to a plurality of processing units, wherein the plurality of processing units execute at least two of the plurality of tasks in parallel.

15. The method of claim 11, comprising generating a data manager, wherein the data manager is configured to provide batches of the data to the plurality of worker pods.

16. A non-transitory computer readable medium having instructions stored thereon, wherein the instructions, when executed by at least one processor, cause a device to perform operations comprising:
receiving a request identifying a payload for execution;
generating a plurality of tasks based on the payload;
generating a work queue and a results queue;
generating a plurality of pods, each of the plurality of pods comprising a checkpoint synchronization container and a checkpoint recovery container, wherein:
the checkpoint synchronization container for each pod iteratively stores a value in an object store when the corresponding pod processes a threshold amount of data for a task of the plurality of tasks; and
the checkpoint recovery container for each pod reads the value in the object store before processing the task, and determine, based on the value, a data location to begin processing the data;
providing the plurality of tasks to the work queue to be processed by the plurality of pods; and
receiving processing results of the plurality of pods from the work queue.

17. The non-transitory computer readable medium of claim 16 further comprising instructions stored thereon that, when executed by at least one processor, further cause the device to perform operations comprising generating a master node, wherein the master node is configured to write the plurality of tasks to the work queue, and retrieve the processing results from the results queue.

18. The non-transitory computer readable medium of claim 16 further comprising instructions stored thereon that, when executed by at least one processor, further cause the device to perform operations comprising generating a training container for each of the plurality of pods, wherein each training container executes the task based on the data location.

19. The non-transitory computer readable medium of claim 16, further comprising instructions stored thereon that, when executed by at least one processor, further cause the device to perform operations comprising assigning the plurality of pods to a plurality of processing units, wherein the plurality of processing units execute at least two of the plurality of tasks in parallel.

20. The non-transitory computer readable medium of claim 16, further comprising instructions stored thereon that, when executed by at least one processor, further cause the device to perform operations comprising generating a data manager, wherein the data manager is configured to provide batches of the data to the plurality of worker pods.
